(19) United States
(12) Patent Application Publication
(10) Pub. No.: US 2002/0087352 A1
(43) Pub. Date: Jul. 4, 2002

(54) The ad machine

(76) Inventors: Mark Armstrong, Atlanta, GA (US); John Dooley, Marietta, GA (US)

Correspondence Address: GARDNER GROFF & MEHRMAN, P.C., PAPER MILL VILLAGE, BUILDING 23, 600 VILLAGE TRACE, SUITE 300, MARIETTA, GA, 30067, US

(21) Appl. No.: 10/038,991

(22) Filed: Dec. 31, 2001

Related U.S. Application Data
(60) Provisional application No. 60/258,942, filed on Dec. 29, 2000.

(51) Int. Cl. G06F 7/00

(52) U.S. Cl. 705/1

(57) ABSTRACT

An ad-making system for receiving ad definitions from users and rendering ads based thereon, with the ad definitions including selections of one or more controlled resources. The controlled resources can include ad templates, photos, headlines and ad body text, user logos, co-branding logos, special offers, and the like that are pre-approved for use by particular users and stored in a database to be accessible by those particular users. The ad-making system can be implemented as an application service provided on a global computer network such as the Internet for remote use by a large number of users each affiliated with one of a large number of clients.

### CROSS REFERENCE TO RELATED APPLICATION

This application claims the priority benefit of U.S. Provisional Patent Application Ser. No. 60/258,942 filed Dec. 29, 2000, which is hereby incorporated by reference in its entirety.

### TECHNICAL FIELD

This invention relates generally to the field of network-based application systems and, more particularly, to an advertisement-making system configured for enabling multiple remote users to create ads by selecting ad components from libraries of controlled ad resources that are pre-approved for use by the users.

### BACKGROUND OF THE INVENTION

When making advertisements, many companies seek the assistance of advertising agencies in order to produce effective and professional ads. The ad agency interviews the client company to determine its needs, brainstorms for ad campaign concepts, presents these to the client for approval, and prepares an ad or series of ads for the client.

For large clients with a number of advertisers, however, this process is not entirely satisfactory. For example, some hotel chain clients have many and dispersed locations each requiring local advertising. The same is true for many grocery stores, restaurants, auto dealerships, department stores, and so on. Requiring each individual advertiser to make its local ads with the assistance of the ad agency, then obtain approval for them through the client main offices, can be time consuming, inflexible, and inefficient.

But if the individual advertisers were to short-circuit the process and make their own ads locally, then the main client would, at least to some extent, lose control over the advertising activities of the advertisers. Generally, it is important for the clients to maintain such advertising control in order to maintain a consistent and high quality of the ads and to ensure that only approved logos, photos, coupons, promotional programs and other resources are used in the ads. This is especially true when the main client is a franchiser and the individual advertisers are franchisees.

Also, many ads are merely an assemblage of pre-existing photographs, logos, headlines, standard couopons, catch phrases, etc. These pre-existing ad resources were created by someone, and that someone may have legal rights in his or her creation. For example, persons involved in the creation of a photograph, such as the photographer, any models, any persons providing assistance with lighting, posing, background selection, or other creative contributions, typically have legal rights in their contributions to the photograph. Therefore, it is important for a client to obtain the permission of these persons before using the photo in an ad. But freelancing local advertisers sometimes overlook this approval process, thereby exposing the client to legal liability for the local advertisers actions.

Accordingly, a need remains in the art for a method and system for making ads by a large number of individual advertisers affiliated with a client, while still aid allowing the client to maintain control over the ad-making process. Furthermore, there is a need for an ad-making system that provides the advertisers the flexibility and efficiency that they desire in making reusable ads particularly suited for their local advertising needs. Moreover, there is a need for a business method for creating and/or operating a system for providing these advantages.

### SUMMARY OF THE INVENTION

The present invention includes an ad machine that enables users to define an ad by selecting ad templates for the particular type of advertisements they want to make, then selecting ad resources for insertion into the ad template to make the ads. The ad templates and ad resources are pre-approved for use by users affiliated with a particular client, and access to them is limited to, and access is controlled for, those particular users. In this way, the user can make ads quickly and easily, with no (or at least significantly reduced) legal liability from misusing ad resources, as can happen in conventional ad-making methods.

Also, the ad machine may enable the users to customize their ads with ad resources for which they do not have pre-approval. The users simply submit the non-controlled ad resource, and the ad machine obtains or confirms receipt of the necessary approval and stores the now-controlled resource for future use by the user (or other affiliated users). If the approval is not received, then the user is not permitted to use it in its ads. In this way, the ad machine provides the users with great flexibility in developing ad resources and making ads while still providing the clients with control over the ads made by their users.

Additionally, the ad machine may provide for producing reports based on the controlled resources selected by the users and on the ultimate success of the ads. By using these reports, the clients can better tailor their advertising campaigns to produce increased user sales for the benefit of the clients and all their users.

Furthermore, the ad machine may be implemented on a global computer network such as the Internet. A large number of clients such as chains or franchisers of hotels, restaurants, auto dealerships, etc., and their widely dispersed ad-making users, can all access the ad machine via the network. With this configuration, the users can make ads best suited to their local needs in a timely manner and, if an approval is needed, it can be quickly and easily obtained without having to manually coordinate every ad with their headquarters.

Generally described, the ad machine includes an ad server with a database of controlled resources usable for the construction of ads by an authorized set of users. The ad server also includes control logic for providing the authorized users with access to the controlled resources. Additionally, the ad server includes rendering logic for rendering ads using the controlled resources in accordance with the control logic.

The controlled resources may include ad templates, photos, headlines, ad body text, user logos, co-branding logos, and/or special offers. In addition, the controlled resources may include other ad resources, such as clip art, basic geometric figures, catch phrases and adages, and/or the like.

Preferably, the control logic provides for receiving ad definitions including one or more of the controlled resources from the authorized users, and finalizing the ad based on the approved ad definitions. The control logic may also provide for submitting a request for an approval of the ad definitions, and receiving the approval.

In order to permit customization of ads, the control logic may provide for receiving an ad resource not stored in the database, submitting a request for an approval of the ad resource, receiving the approval, and storing the resource in the database as one of the controlled resources. Accordingly, if the user (or another user associated with the same client) wants to use the same resource again in future ads, it can do so without having to obtain approval again.

In one aspect of the invention, each ad template may have a number of the other controlled resources correlated to it that are suited for use with the template. When the user selects the ad template, the control logic provides for sending the correlated controlled resources to the user for display. Then the user can select from these suggested controlled resources to make the ad.

In other aspects of the invention, the control logic may provide for amending and appending the controlled resources, establishing a hierarchy of user access defining different levels of access rights, password protection for security, and billing the users. Also, the control logic may provide for maintaining records relating to the use of the controlled resources and producing reports based on the records.

Preferably, the rendering logic provides for extracting an image from the database, parsing out a desired part of the image, scaling the parsed image to fit within an image box in a selected ad template, and rendering a bit map of the ad template and the parsed image. Then the rendered bit map is displayed to the user, and the generated ad can be printed by the user or sent to a graphics server for print preparation, a legal server for approval, or elsewhere. The rendering logic can be stored on an ad server, on the individual user devices, or on both.

Also, the ad server may contain a plurality of client files, with each client file accessible only by a corresponding client and its users. In this embodiment, each client file is typically correlated to the controlled resources that have been preapproved for use by the client and its users.

Another aspect of the invention includes a computer-storage medium (which may be a single medium or a group of media) with the database, the control logic, and the rendering logic stored on it. Yet another aspect of the invention includes the ad server, a graphics server, and a legal server connected to the user devices via a communication network. Still another aspect of the invention includes a method of constructing an ad-making apparatus. More specifically, this aspect of the invention includes the steps of defining the controlled resources and the control logic, deploying the controlled resources and the control logic on a computer system, and providing access to the users in accordance with the control logic. Also, this method may include obtaining or creating the ad resources, submitting an approval request for using the ad resource, receiving the approval, and storing the approved ad resource as a controlled resource.

In view of the foregoing, it will be appreciated that the present invention greatly facilitates the ad-making process using controlled resources and the advantages of on-line and distributed computer resources. The specific techniques and structures employed by the invention to improve over the drawbacks of the prior systems and accomplish the advantages described above will become apparent from the following detailed description of the embodiments of the invention and the appended drawings and claims.

### BRIEF DESCRIPTION OF THE DRAWINGS

FIG. 1 is a functional block diagram illustrating an ad-making system according to an exemplary embodiment of the present invention.

FIG. 2 is a block diagram illustrating the components of one client file stored on the ad server of FIG. 1.

FIG. 3 is a logic flow diagram illustrating a process of creating the ad-making system of FIG. 1.

FIG. 4 is a logic flow diagram illustrating a routine from FIG. 3 for selecting and updating controlled resources to be used in the ad-making system.

FIG. 5 is a logic flow diagram illustrating a process of making an ad using the ad-making system of FIG. 1.

FIG. 6 is a logic flow diagram illustrating a routine for defining the ad.

FIG. 7 is a logic flow diagram illustrating a routine from FIG. 6 for selecting and updating controlled resources to define the ad.

FIG. 8 is a logic flow diagram illustrating a routine from FIG. 5 for purchasing and printing the ad.

FIG. 9 is a welcome screen for display on the user's interface device.

FIG. 10 is an exemplary user identification display screen.

FIG. 11 is an exemplary new user display screen.

FIG. 12 is an exemplary activity selection display screen.

FIG. 13 is an exemplary activity information display screen.

FIG. 14 is an exemplary ad topics display screen.

FIG. 15 is an exemplary ad template display screen.

FIG. 16 is an exemplary preview ad display screen with the selected ad resources inserted into the selected ad template.

FIG. 17 is an exemplary customizing display screen.

FIG. 18 is an exemplary special offer screen.

FIG. 19 is an exemplary completed ad display screen.

FIG. 20 is an exemplary purchase display screen.

FIG. 21 is an exemplary checkout display screen.

FIG. 22 is an exemplary purchase receipt display screen.

FIG. 23 is a logic flow diagram illustrating an alternative routine for rendering the ads based on the selected controlled ad resources.

FIG. 24 is a functional block diagram illustrating the system architecture of an ad-making system according to an alternative embodiment of the present invention.

### DETAILED DESCRIPTION OF THE EXEMPLARY EMBODIMENTS

The present invention is preferably embodied in an ad-making application service provided on a global computer network such as the Internet. Generally described, the service permits a remote user to access its client file that stores ad templates and other controlled resources such as photographs, ad headlines, ad body text, user logos, co-branding logos, special offers, and the like. The user selects an ad template and controlled resources to create the ad, and the ad is displayed to the user with the selected controlled resources inserted into the selected ad template. At this point, the user can finalize the ad and have it sent to a graphics server that prepares the ad for printing.

The ad templates and controlled resources are stored in the file of each client whose users have been pre-approved to use them in ads. In this sense, the ad templates and controlled resources are “controlled.” The pre-approval process involves obtaining releases or other documentation providing the user with permission to use the photographs or other resources in its ads. In this way, the ad-making process is streamlined and centralized while exposing the user to reduced or no legal liability for its use of ad resources, because the user can quickly and easily make its ads using its library of the pre-approved ad resources.

This streamlined and centralized ad-making process is particularly advantageous for use by frequent advertisers that are franchisees of a chain of businesses. For example, hotels often advertise in newspapers and magazines on a daily or weekly basis. By using the ad-making service, each individual hotel (the user) can make ads by accessing the client file for the hotel chain (the client). In this way, each hotel can make its own ads without routing each of them through the chain headquarters for approval, thereby making the ad-making process more flexible and efficient.

Additionally, the ad-making service may use a reports generator and a statistics database to enable the clients to generate a wide variety of useful reports. If desired, the service can be provided to automatically update the statistics database for each user, each client, or a group of user or clients. For example, the statistics database can be automatically updated with the number of times a user selects each of the controlled resources, the particular combination of controlled resources selected, the media in which the ad is published, the identity of the particular user, and so forth. Also, the service may enable the users (or others) to manually input data relating to the ultimate success of the ads made using the service. The reports may be in any conventional format desired, and the users may be allowed to create their own report format to meet their particular needs. Of course, the reports may be produced using other computer components and configurations that are known to persons of ordinary skill in the art.

Furthermore, the ad-making service may enable the users to make ads with special offers such as discounts, coupons, rebates, giveaways, sweepstakes offers and the like. Along with each special offer, the ad-making system may automatically insert standard legal language such as disclaimers, rules of eligibility, redemption requirements, offer effective and termination dates, etc., into the body of the ad. In addition, for certain special offers, some of this language may be required to complete the ad (e.g., the termination date for a limited time coupon), while other language may be optionally selected by the user for inclusion in the ad. Also, some of the language may be selected using a “fill-in-the-blanks” format (e.g., termination date), in a pull down menu, whereas the user may enter other types of data in free text formats, or using another appropriate data entry technique.

The system may also display rules or suggestions to guide the user when preparing, distributing, or recording statistics regarding the results of the ad, which are not necessarily included in the body of the ad. It will be understood that other types of special offers, associated legal language and rules, and display and selection techniques may be added to the system or may replace those described above.

Moreover, the ad service may enable a variety of standard or custom-designed billing techniques specially adapted for use therewith. For example, the service may include billing methodology for billing the users, the clients, or both in accordance with a pre-determined formula. In addition, the billing methodology may permit billing based on the particular controlled resource selected and used by the corresponding client, and/or based on the total number of controlled resources selected and used. In this way, more can be billed for resources that, for example, are the most successful in advertising or for which approval was more costly. Also, the billing methodology can provide for charging a flat fee based on a set time period (say, per month or year) regardless of the amount of ads made, based on the number of users per client, based on the media advertised in, based on the ad topics to be used, or a combination of these. Of course, the billings can be produced using other methodologies based on the number of retail outlets using the ad, the number of copies of the ad printed, or another suitable billing parameter.

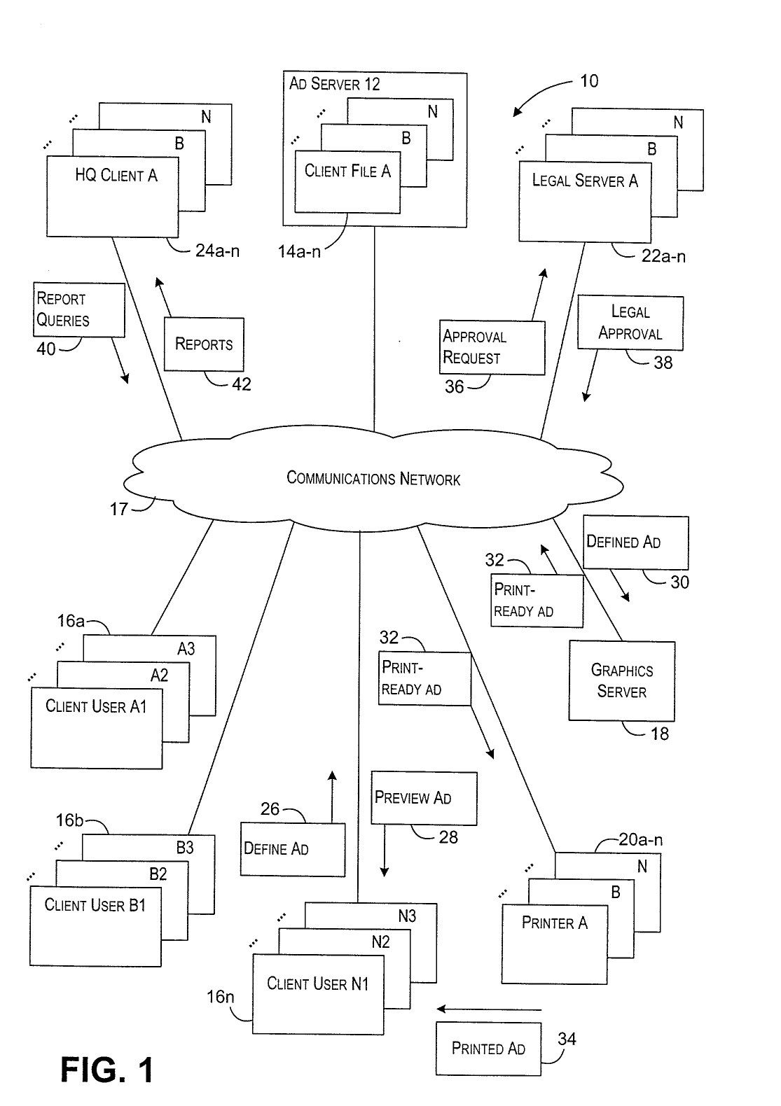

Turning now to the drawing figures, in which like numerals indicate like elements throughout the several figures, FIG. 1 is a functional block diagram illustrating the system architecture of an ad-making system 10 according to an exemplary embodiment of the present invention. The system 10 includes an ad server 12 with a processor and a computer-readable storage medium such as a hard drive, a CD-ROM disc or other medium for an optic drive, and/or a magnetic tape, disc, or other medium for such a drive. The storage medium stores client files 14a-n for one or more clients each having one or more users. The client files 14a-n include ad templates and controlled resources that are pre-approved for use by the corresponding client users to make ads.

The system 10 is preferably implemented as an ad-making application service provided on a global computer network. Accordingly, the ad server 12 can have an on-line interface configured to communicate with a number of remote user devices 16a-n via a communications network 17 such as the Internet, a wireless network, or another computer network. Alternatively, the ad server can be connected to a computer network 17 such as an intranet or a LAN for use by users that are local to the ad server, such as in a business headquarters where the ad-making users reside in the headquarters. The user devices 16a-n can include desktop computers, laptop computers, hand-held computers, PDA's, web-enabled phones, or other communication devices connected to the network.

Each of the client files can be accessed not just by one user, but by a number of users that are associated with the client. For example, where the client is a hotel chain, the users can be the individual hotels affiliated with the client chain. Accordingly, users A1, A2, and A3 can be the individual hotels affiliated with the hotel chain client, and each hotel/user can access the client file 14a. Similarly, users B1, B2, and B3 can be individual restaurants affiliated with the restaurant chain client, and each restaurant/user can access the client file 14b. It will be understood, then, that “client” refers to a franchiser or other main business, and “user” refers to the individual users that are affiliated with the client.

Additional components can be connected to the network to communicate with the ad server 12 to implement the system 10. These additional components can include a graphics server 18, printers 20a-n, legal servers 22a-n, and client headquarters servers 24a-n. The graphics server 18 is configured for preparing the ad templates and controlled resources into print-ready ads for the printers 20a-n to print. The graphics server 18 and the printers 20a-n can be located in a centralized place with the ad server 12, at the client's main office, at a print shop local to the user, on-site at the user's place of business, or elsewhere. The legal servers 22a-n and the client headquarters servers 24a-n are computers located at a main or local business office of the client, though they could be placed elsewhere for convenience. Of course, other system architecture can be employed to provide the functionality described herein.

In operation, the ad server 12 receives ad definitions 26 from one of the users, for example, user 16n. The ad definitions 26 include a selection of one of the ad templates and a selection of one or more of the controlled resources from the corresponding client file 14n. The ad server 12 then sends a preview 28 of the defined ad to the user 16n for display with the selected controlled resource inserted into the selected ad template. If the user elects to purchase the ad, then the finalized defined ad 30 is sent to the graphics server 18 for preparation into a print-ready ad 32, and the graphics server 18 sends the print-ready ad 32 to the printer 20n. The printer 20n prints the ad 34, and it is delivered to the user 16n or to a publisher specified by the user. Alternatively, the graphics server 18 can send the print-ready ad 32 directly to the publisher for printing or, where high resolution is not required, the user can simply print the defined ad without using the graphics server.

The system 10 also permits the users to submit ad resources that are not pre-approved and stored in their client file. For example, the user may want to use a photograph that has not been pre-approved for the user to use in ads. In this case, when the user inputs such a non-controlled resource, the ad server 12 sends (or prompts the user to send) an approval request 32 to the legal server. If approval is obtained from the necessary entities for use of the resource, then a legal approval 34 is sent to the ad server 12 and the resource is stored in the client file 14n as a now-controlled resource. The legal approval 34 or an indication thereof can also be stored in the client file to document that the approval has been obtained.

Additionally, the ad server 10 can include a reports generator and a statistics database for storing statistics relating to the user, the ad templates and controlled resources selected by the user, and/or other related statistics. For example, the statistics database can store statistics of the number of times a user selects each of the controlled resources, the particular combination of controlled resources selected, the media in which the ad is published, and so forth. Also, the statistics database can store data manually input by the users such as the success of particular ad resources. Then the client's headquarters server 24n (or another server associated with the client) can send a report query 40 to the ad server 12. The ad server 12 loads the statistics into the reports generator and sends the resulting reports 42 to the headquarters server 24n. The reports can be in any convention format desired. In this way, the client's headquarters can track data relating to the ads made by the users and make inventory adjustments to its client's file, coordinate chain-wide marketing campaigns based on the individual users advertising, and so forth.

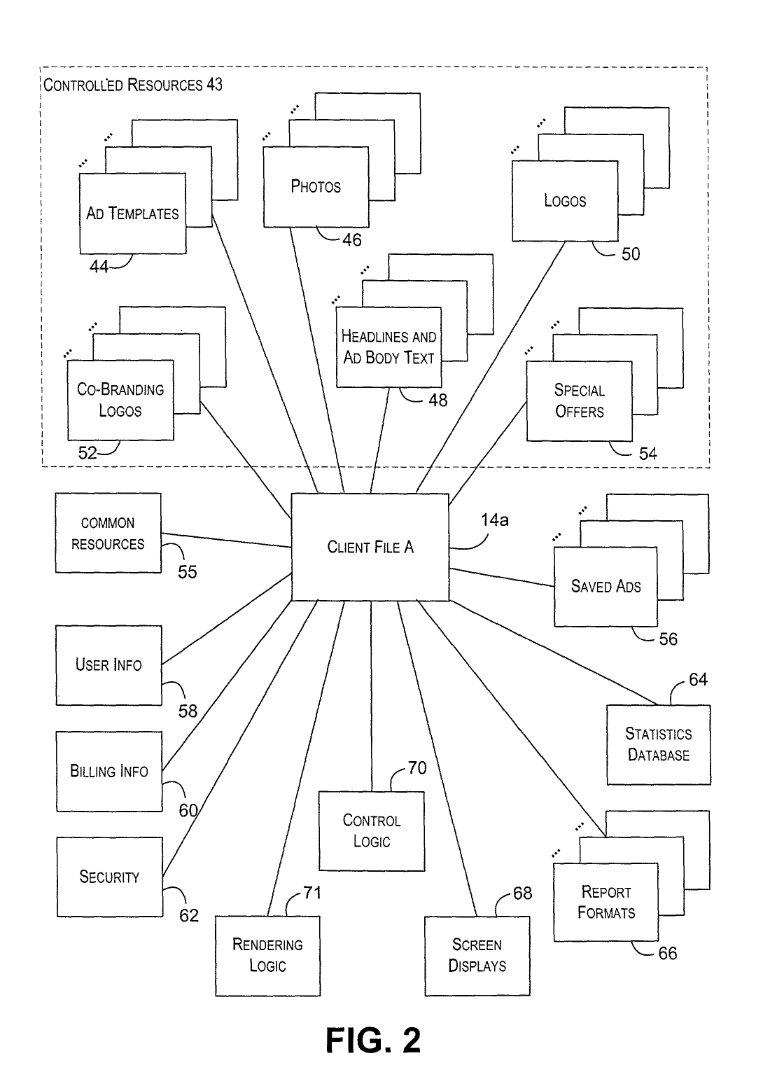

FIG. 2 is a block diagram illustrating the components of one of the client files 14a stored on the ad server 12. The client file 14a includes libraries of the controlled resources 43 that have been pre-approved for use by the user (or by a number of users affiliated with the client) corresponding to that file. It will be understood that when it is said herein that the controlled resources 43 or other components shown are stored in or included in the client file, this includes that they are stored in a database or other software on the computer-readable medium at locations that are correlated to the client file or a component thereof, and not necessarily that that they are physically stored or included in every client file for which they are pre-approved.

The controlled resources 43 include ad templates 44, photos 46, headlines and ad body text 48, user logos 50, co-branding logos 52 that are pre-approved for use only with predetermined ones of the user logos, special offers 54, and/or other ad components that can be used in an ad and stored electronically in the client files. The ad templates 44 can have correlated thereto, for example, a suggested headline, photo, and/or body text for display. Also, the ad templates 44 can have correlated thereto for display optional headlines, photos, and/or body texts, or a menu of these, for selection by the user. It will be understood that the term “logo” as used herein includes words, names, symbols, devices, and/or combinations thereof that are trademarks or are intended to be used as trademarks.

Also, common resources 55 can be provided for use by any of the users. Such common resources can include clip art, statistics, photos that can be used for ad-making in multiple industries, newspaper articles, software plug-ins and updates, and other ad-related or computer system-related items for which approval has been received or is not needed.

The client file 14a can also include saved ads 56 that the user has previously made. These saved ads 56 can be later re-accessed for reuse as is, or they can be modified with different photos, etc.

Also, the client file 14a can include user information 58, billing information 60, and user security information 62. The user information 58 can include details about the user such as its business name and address. The billing information 60 can include billing details such as payment method, payment terms, whether the client or the user is to be billed, etc. The user security information 62 can include authorization information such as user ID's and passwords that are correlated with the corresponding client files, encryption technology, a hierarchy of users with varying access limitations, and so forth.

Additionally, the storage medium stores the statistics database 64 and the report generator 66. As mentioned herein, the statistics database 64 stores statistics relating to the ads made by the user when using the system, and the reports generator 66 includes report formats for displaying the statistics in a useful form. Of course, the reports generator 66 can be customized with user defined report formats, as is known in the art.

Furthermore, the storage medium stores screen displays 68, control logic 70, and rendering logic 71 for the on-line application service. The screen displays 68 are sent to the user devices for display thereon to enable the users to select the desired ad templates and controlled resources, and to enter other data such as ad purchasing data. The rendering logic 71 provides for rendering a bit map of the ad based on the selected ad template and the selected controlled resources.

The control logic 70 includes implementation methodology that enables the users to select from the ad templates 44 and other controlled resources 43 that have been pre-approved for them. Also, the logic 70 can be defined for enabling the ad server to receive special offer terms, or a selection of one or more predetermined special offer terms, from the user when it selects one of the special offers 54. For example, when one of the special offers 54 is selected, the offer ending date, the discounted price, or other terms of the special offer can be entered by the user.

Additionally, the logic 70 can be defined for enabling the ad server to receive a selection of one or more of the co-branding logos 52 that are pre-approved for use with a selected user logo 50. But other logos not approved for use by the user can not be selected by the user. To accomplish this, the client files include only co-branding logos that have been pre-approved for user by the user and/or with the user's logo. In this way, where the client has co-branding arrangements with other parties, the user can incorporate the other parties'logos into its ads. For example, a hotel user may want to include an airline logo in its ads in accordance with an agreement between the hotel client and the airline. Also, rules for using the co-branding logos, such as the logo's size or position in an ad relative to the user's logo, can be stored on the storage medium, and the logic 70 can provide for displaying the corresponding rules to the user when one of the co-branding logos is selected.

Furthermore, the logic 70 can be defined for enabling the ad server to receive a resource not stored in the client file from the user to customize the ad. For example, the user may want to include in its ad a photo for which it does not have pre-approval for use. In this case, the ad server sends an approval request for use of the resource to the legal server and, if an approval is received, the ad server stores the resource in the client file as one of the controlled resources 43 and associates the now-controlled resource with the selected ad template 44.

Moreover, the control logic 70 can include methodology for providing selective hierarchical access to the client file based on the user information 58 and the user security information 62, producing reports using the report formats 66 and database 64, and/or processing payments based on the billing information 60 and the user information 58. Of course, the logic 70 can include additional or alternative logic to carry out the same or other functions, as may be desired.

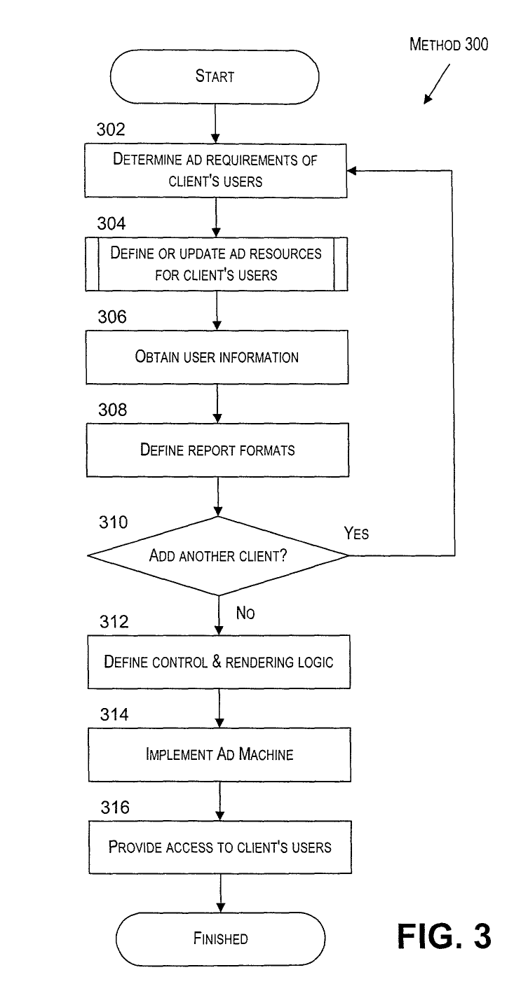

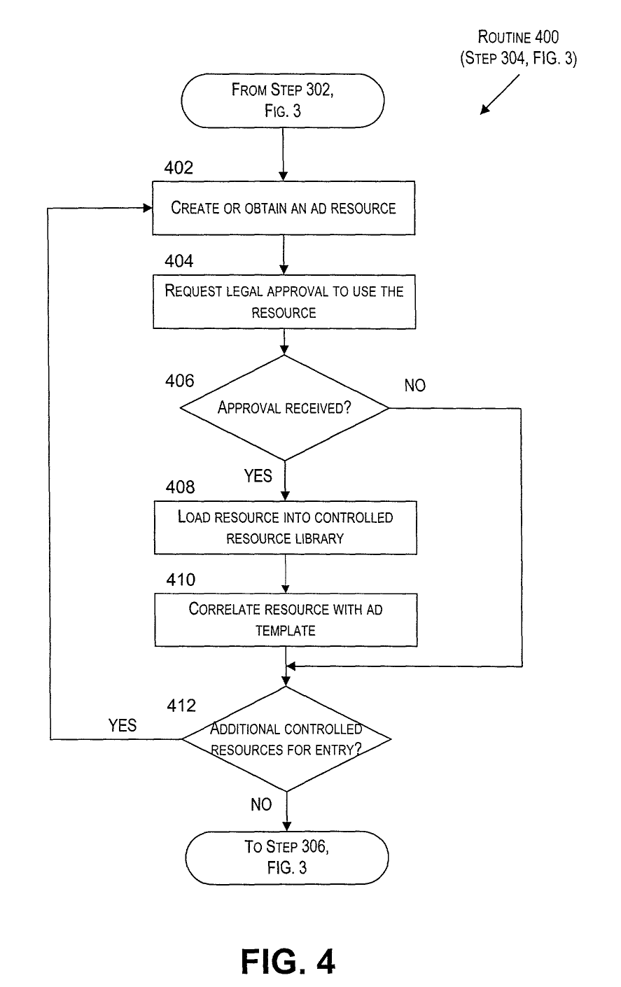

FIG. 3 is a logic flow diagram illustrating a method 300 of creating the admaking system of FIG. 1. The method 300 can be carried out by an advertising agency, marketing personnel with a franchiser or main office of the client, the application service provider, or by another party. The method 300 includes at 302 determining the advertising requirements of a client's users. This can involve determining the types of advertising the client's user's do, the media advertised in, the types of ad formats employed, the types of ad resources used, etc. Based on this information, the method at 304 includes defining ad templates and other ad resources meeting the user requirements. The other ad resources can include photos, headlines, ad body text, user logos, co-branding logos that are pre-approved for use only with predetermined ones of the user logos, special offers, etc.

Next, at 306 the method includes obtaining user information from the client or user such as the number and identity of the users, billing information, details of the user's on-line interface devices to ensure connectivity, and so forth. Based on this information and the user requirements, the method at step 308 includes defining report formats to present the client with desired ad-related data, and configuring a statistics database for storing the data. At 310, if another client is to be added to the system, then steps 302-308 are repeated for the next client, and so on until all the desired client users have been processed.

Based on the obtained information, at 312 the control and rendering logic is defined for the on-line application service. The logic is defined for permitting the user to select one or more of the ad templates and one or more of the controlled resource to make an ad. Also, the logic can be defined for requiring the user to select one or more special offer terms or one or more predetermined special offer terms when it selects one of the special offers. Additionally, the logic can be defined to permit the user to select a co-branding logo for use with a pre-determined user logo, but only for such use. Furthermore, the logic can be defined to permit the user to customize the ad by carrying out the process described below in resource approval routine 400.

Then at 314 the service is implemented by deploying the controlled resources and the control logic on a computer configured, for example, as web server with a processor, an on-line interface, and a computer-readable storage medium. The ad templates and other controlled resources, statistics database and reports generator, client information, and the control logic are stored on the storage medium, with the ad templates, controlled resources, and user information stored in a dedicated client file for the client users. And at 316 the service is connected to a communications network such as the Internet so that the users can remotely access the service.

FIG. 4 is a logic flow diagram illustrating the routine 400 of step 304 for defining and controlling the ad templates and other ad resources. Previously, at 302 the user requirements were determined. Now at 402, the ad resources are created or obtained based on these user requirements. For example, photographs that fit the advertising themes of the client users can be made, or where pre-existing photographs can be found, those can be purchased or otherwise obtained. Similarly, ad headlines and body text from previous ads by the user can be copied, or new ones can be written. Also, the templates and ad resources can be selected with consideration to whether the ads will be newspaper ads, magazine ads, outdoor/billboard ads, etc.

At 404, legal approval is requested for the user to use the ad templates and resources in ads. The approval can be requested from the appropriate entities manually or via a legal server operated by the legal department of the client or by the application service provider. The legal approval can include releases from the photographer and models in the case of a photo, from the author in the case of an ad template, ad headline, or ad body text, from the owner of another logo in the case of co-branding, and so forth.

If the approval is received, then at 408 the approved ad templates and the approved resources are stored as controlled resources in a client file corresponding to the user. The user and the client file can be correlated for the only the user to have access to the file by the user establishing a user identifier such as a user name and password. Next, at 420 each of the stored controlled resources are correlated with one or more of the ad templates so that when the ad template is selected, the correlated controlled resources or a menu thereof will displayed to the user for its selection. The resource is now controlled because its approval has been received (and stored, typically), it has been stored in the controlled resources library of the client file, and the client file has been security-coded by correlating it to the user identifier for access only by the corresponding user or users. At this point, step 412, the process of steps 402-410 can be repeated for additional ad resources.

If the legal approval is not received at step 406, then the ad resource is not loaded into the controlled resources library of the client's file (because this is not a controlled resource). In this way, the user can confidently make an ad knowing that the legal permissions for the controlled resources have been secured. From 406, the process continues at step 412 until the all the desired ad resources have been processed, then the method continues at step 306. Also, this routine 400 can be used by the service provider, the advertising agency, the client or user, or others to maintain the cite by updating (amending or appending) the ad templates and the other controlled ad resources to meet changed the user requirements.

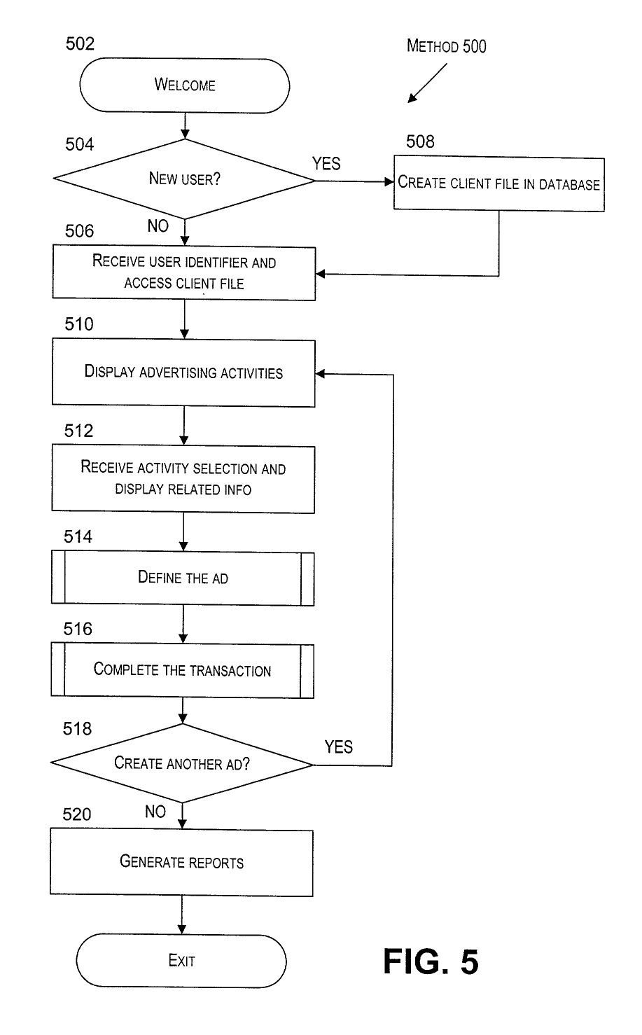

FIG. 5 is a logic flow diagram illustrating a method 500 of making an ad using the ad-making system of FIG. 1. Thus, the method can be implemented as an application service provided by an ad server connected to a communications network such as the Internet. The ad server is programmed to carry out the functionality of the method 500, which programming can be performed by a computer programmer of ordinary skill in the art.

The method 500 includes at 502 the ad server sending a welcome screen to the user for display on its on-line user interface device. An exemplary welcome screen 100 is shown in FIG. 9. If desired, the welcome screen can include a window for the user to enter a company code that will lead the user through a pre determined routine. A routine for making an ad is described herein, however, the user can alternatively be lead through a routine for selecting one of several approved user logos for printing, or through another routine.

At 504, the ad server sends a screen to the user for display that allows the user to indicate whether it is a new or existing user. An exemplary such screen 102 is shown in FIG. 10. This screen can include windows 104 for an existing user to enter at 506 one or more user identifiers such as a user name and password, an email address, etc. Data relating to the existing user such as the identity of the user and/or the log-on time can now be saved to a statistics database for use in generating reports, as herein.

The ad server then accesses the client's file by finding the file on the storage medium that is correlated to the user's identifier. A plurality of client files can be stored on the storage medium, with each file dedicated to one or more of the client's users and storing ad templates and controlled resources pre-approved for that or those particular user or users. As mentioned herein, the controlled resources can include photos, headlines, ad body text, user logos, co-branding logos that are pre-approved for use only with predetermined ones of the user logos, and special offers.

If the user has not used the service before, then at 508 a new user screen 106 is displayed for the user to enter certain required information. An exemplary new user screen is shown in FIG. 11. Here the user is provided with fields 108 for entering information such as its name, location (if there are multiple sub-user locations), contact information (address, phone number, fax number, email address, etc.), user name and password, security information such as a user identifier (e.g., its password), advertising property type, and so forth. The method then continues at 506 where the user's identifier is received and its client file accessed.

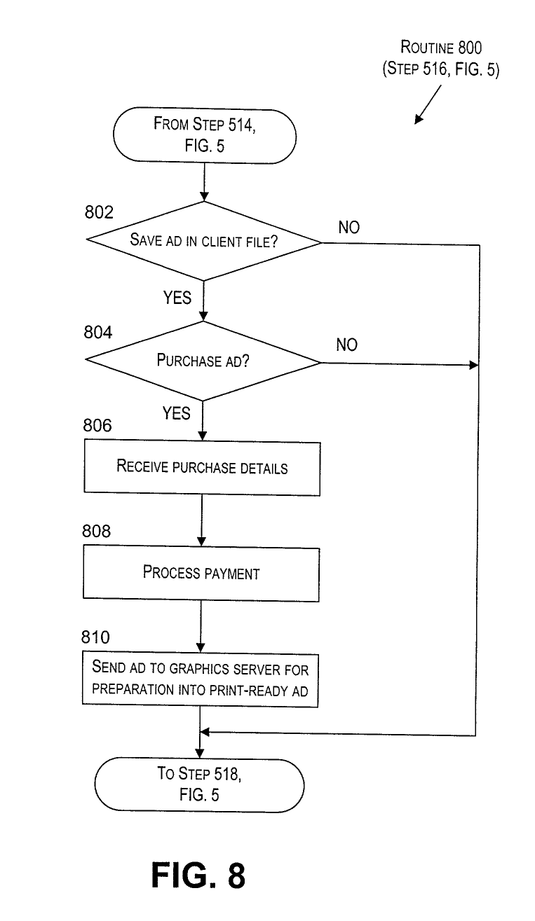

Next, a menu 110 of activity selections is displayed to the user at 510. The activities can include newspaper, magazine, or outdoor (billboard) advertising, or another media for advertising. An exemplary activity selection screen 112 is shown in FIG. 12. Then at 512 the user selects one of the activities displayed. This selection can then be recorded to the statistical database. If desired, at 512 information 114 relating to the selected activity can be displayed. An exemplary activity information screen 116 is shown in FIG. 13. Such information can include, for example, best uses for the selected type of advertising, what information will be required to make an ad for this type of advertising, and so forth. Also, an option button can be displayed for the user to click to display more about the selected type of advertising. It will be understood that, while the inclusion of these activity selection and information display steps 510 and 512 is preferred, they can be eliminated so that the user is taken directly to the next step described below, if so desired.

At 514, the ad server sends display screens to the user permitting the user to select ad definitions to make an ad. Then at 516, the ad server can receive purchasing details for completing the transaction for purchasing the ad made by the user. After each of these steps, the statistical database can be updated with current ad and user-related data. These steps will be described below with reference to routines 600 and 700, respectively.

If the user wants to make another ad, then at 518 the ad server returns to step 510 of the routine 500, and the process is repeated. If the user is finished making ads, then the ad-making method is completed and the user can exit from the system. A display screen permitting the user to make this selection is not shown, but those skilled in the art will readily appreciate its configuration.

At this point, the user, its headquarters or local office, or another party with security clearance can now generated reports based on the latest ad and user-related data now stored in the statistical database. For example, at 520 the routine can include loading the statistics into a report generator stored on the storage medium, generating reports based on the statistics, and sending the reports to the appropriate entity.

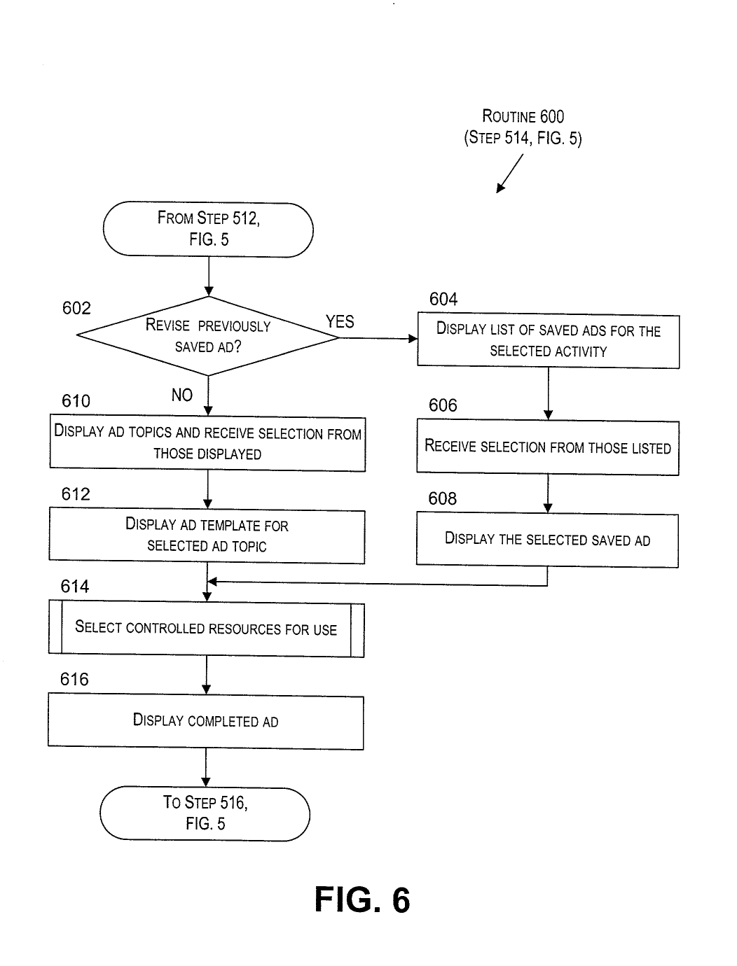

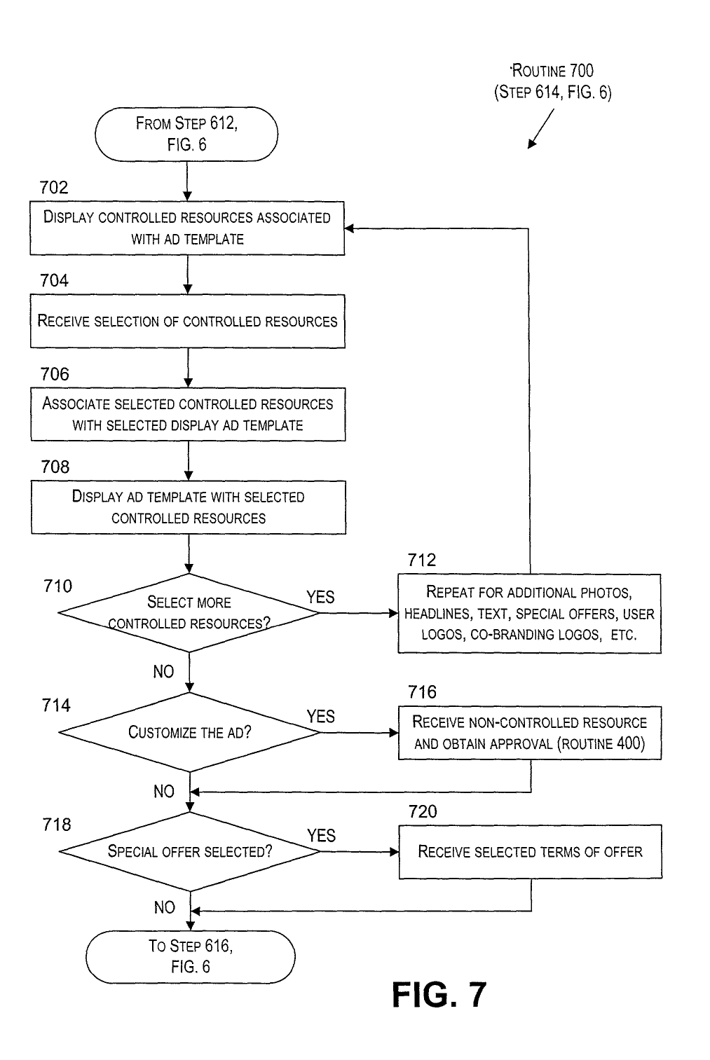

FIG. 6 is a logic flow diagram illustrating the routine 600 of step 514 for defining the ad. Previously, an advertising activity selection was received from the user at step 510 and information relating to the selected activity was displayed to the user at step 512. Now the ad server receives from the user a selection of an ad template from those pre-approved in its client file and associated to the selected advertising activity. One way this can be done is by displaying to the user a menu of ad templates from which it may make a selection.

Another method for permitting the user to select an ad template is by at 602 displaying a box 118 or other indicia for the user to access a previously saved ad. This option can be displayed to the user, for example, on the screen 116 shown in FIG. 13. If the user elects to revise a previously saved ad, then at 604 the ad server sends to the user for display a list of any saved ads correlated to the selected activity, at 606 receives a selection of one of the listed saved ads from the user, and at 608 displays to the user the saved ad for revision. The ad server can then receive selections of different controlled resources to create a different ad, as described in step 614 below.

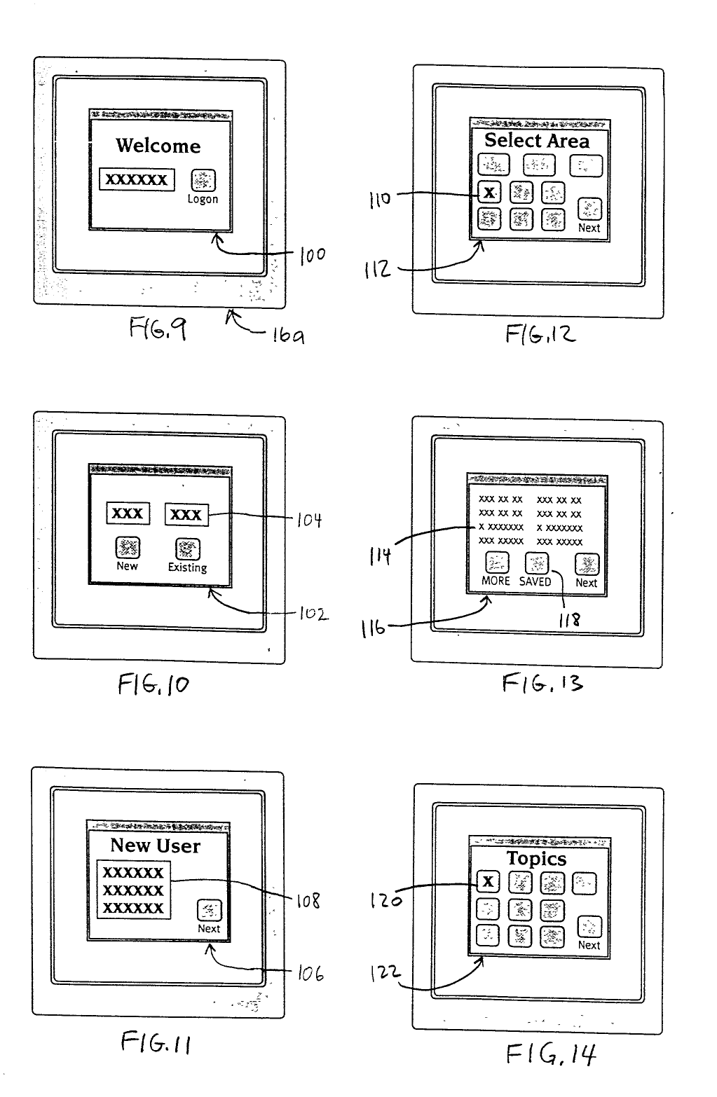

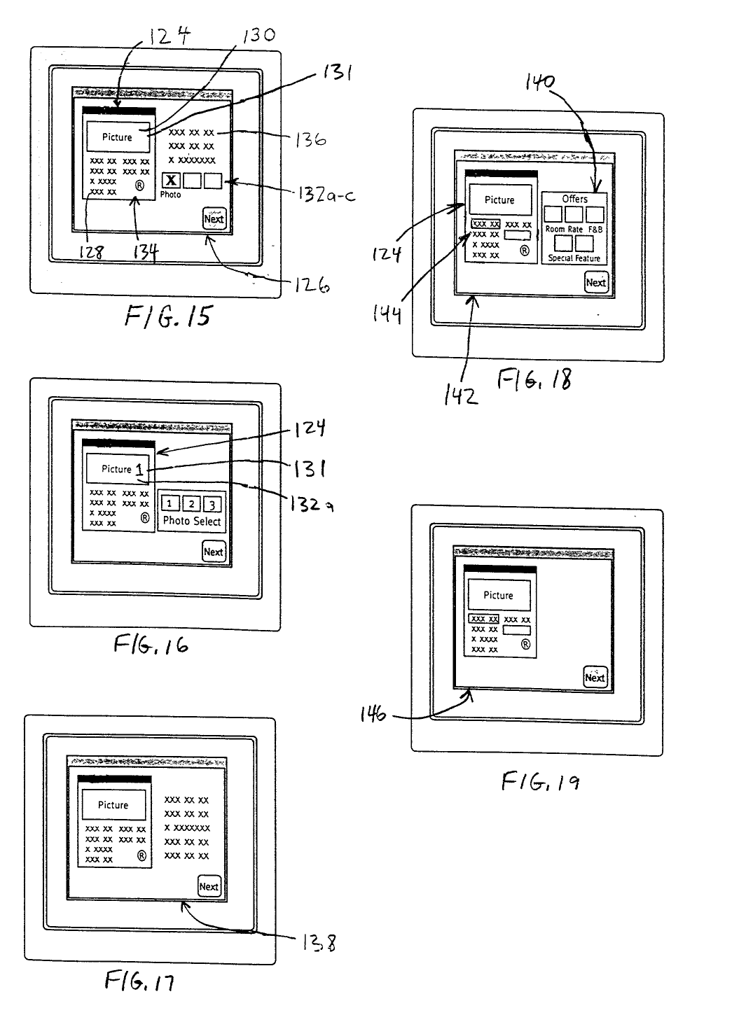

If, however, the user does not select a saved ad for revision at 602, or has no saved ad that can be revised, then the user can be provided with yet other ways to select an ad template. For example, at 610, a menu 120 of advertising topics is displayed to the user, and a selection from those is received by the ad server. An exemplary ad topics screen 122 is shown in FIG. 14. The ad topics can include any of a variety of topics. For example, if the user is a hotel, the ad topics can include weddings (e.g., for advertisements for wedding planning and hosting services), family reunions, business travel, conventions, vacations getaways, and so forth. Each of the ad topics can have an ad template correlated thereto so that when the topic is selected, the correlated ad template is displayed to the user (and thereby also selected). The statistical database can then be updated with the user's ad topic selection.

In any event, an ad template is displayed to the user, whether by selecting an fresh ad template directly, selecting a saved ad template, selecting an ad topic with an ad template correlated thereto, or by otherwise selecting an ad template. Then at 614 the user selects one or more of the controlled ad resources in its client file for insertion into the ad template to make the ad. And at 616 the ad server finalizes the ad and sends it to the user for display with the selected ad resources inserted into the ad template.

FIG. 7 is a logic flow diagram illustrating the routine 700 of step 614 for selecting (or updating) the controlled resources to make the ad. At 702 the selected ad template 124 and one or more of the controlled resources in the client's file, or a menu thereof, is sent to the user for display. An exemplary ad template screen 126 is shown in FIG. 15. Each of the controlled resources are correlated to one or more of the ad templates and pre-approved for use only by approved users. Thus, only predetermined ones of the controlled resources, or a menu thereof, are sent to the user with the selected ad template for display.

The ad template can include for display one or more suggested controlled resources for use therewith. For example, as shown in FIG. 15, the ad template 124 can include a suggested ad body text 128 and a suggested photo 130 in an image box 131, with a menu 132 of three (or another number of) alternative photos that are suited for use with the suggested text. Alternatively or additionally, the ad template 124 can include a menu of alternative ad body texts that are suited for use with the suggested photo. As a further example, ad headlines can be suggested that are suited for use with the suggested photos and text. As an option, the ad template 124 can display the user's logo 134 (or a menu of approved user logos) for selection, and any co-branding logos that are approved for use with the user's logo or otherwise approved for use by the user. Also, the rules 136 for use of the user's logo and/or the co-branding logo can also displayed to the user.

Then at 704 of FIG. 7 the ad server receives a selection from the user of one (or more) of the controlled resources. At 706 the ad server renders the ad by associating the selected controlled resource with the selected ad template, and at 708 it sends these to the user for display with the selected resource inserted into the ad template. For example, if the first photo 132a is selected as shown in FIG. 15, then that photo is inserted into the image box 131 in the ad template 124 where the suggested photo 130 was displayed, as shown in FIG. 16. The statistical database can then be updated. And at 710, if the user wants to make further selections of additional controlled resource, then at 712 the controlled resource selection process of steps 702-706 is repeated.

Additionally, at 714 the ad server can send to the user a display for customizing the ad by permitting the selection of user-defined resources not included in the client's file. An exemplary customizing display 138 is shown in FIG. 17. The user can then customize, for example, the ad text and/or headline be typing in its original text and/or headline, within predetermined space or character number limits. For a photo, user logo, or co-branding logo not pre-approved and stored in the client's file, however, the necessary approval must now be obtained before the resource can be used. Thus, if such a non-controlled resource is received by the ad server from the user at 716, whether by email, direction to a published resource, or otherwise, then the ad server proceeds to the approval routine 400 to obtain or verify that the proper legal permission is received for the use of the non-controlled ad resource. If the approval is received, then the resource is stored in the client file as a controlled resource for present and future use by the user in ads. If, however, the approval is not received, the ad server can send the user a notice that the non-approved ad resource has been declined, or that the ad-making process is on hold and can not continue until receipt of the proper approval. Of course, the ad server can be configured to required that the approval routine can be carried out for all non-controlled resources, even the ad body text and headlines.

While the selection of some of the controlled resources will conclude this phase of the routine, some types of controlled resources require additional inputs. One such type is the special offers. If the user selects one of the special offers at 718, then at 720 the ad server sends to the user a menu 140 for selecting the terms of the offer. An exemplary special offer screen 142 is shown in FIG. 18.

For example, if the user is a hotel, the special offer can be a special room rate, a breakfast special, a discount for kids, and so forth. The terms can include the effective and/or expiration date of the offer, the products or services for which the offer is valid, the locations where the offer can be redeemed, and/or other offer terms. The offer terms can be selected by entering data in a field to “fill in the blanks” of an offer term, by being selected from a menu of offer terms displayed to the user, by being freely entered by the user, or otherwise. The special offer terms 144, including those selected and any required (not selectable) terms, are then displayed in the ad template 124.

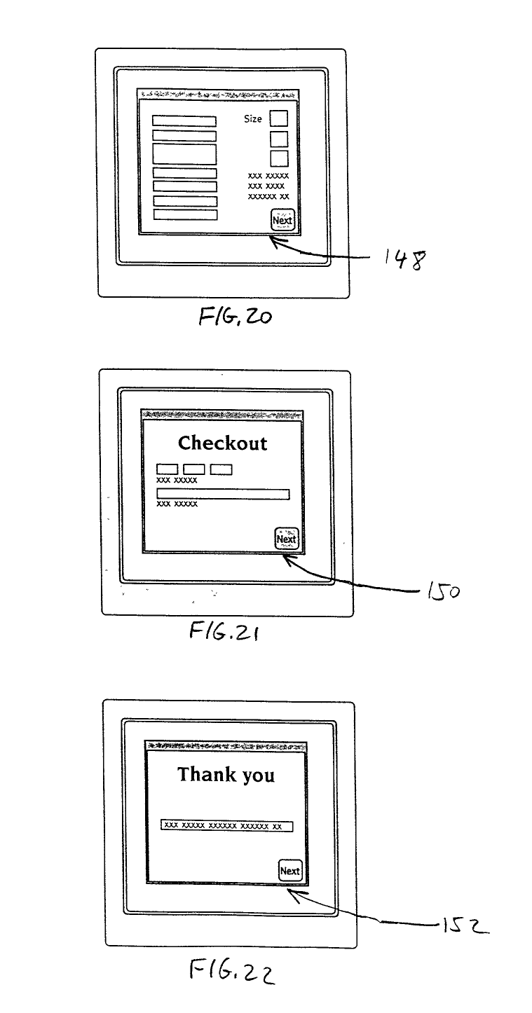

In any event, the user has now selected its desired ad template and controlled ad resources for use with the ad template. Accordingly, the ad definition process is now completed, and the statistical database can be updated to include the user's selections. An exemplary completed ad display screen 146 is shown in FIG. 19.

FIG. 8 is a logic flow diagram illustrating the routine of step 516 from FIG. 5 for purchasing and printing the ad. Previously at step 514 (and the subsequent steps described herein) the ad server received definitions of the ad to be made. Now at 802 the ad server sends to the user a display permitting the user to save the ad for later accessing. Also, at 804 the ad server sends to the user a display permitting the user to purchase the ad it has made. Such an exemplary purchase display screen 148 is shown in FIG. 20. At 806 the user can then enter the purchase details such as the size of the ad, the start date for publication of the ad, the publications in which the ad is to be published, etc.

Then at 808 the payment is processed. For example, the ad server can send a display screen for the user to enter charge card information. An exemplary checkout display screen 150 is shown in FIG. 21. Upon receipt of payment confirmation, or a promise to submit payment later, then at 810 the ad is sent to a graphics server for preparation into a print-ready ad (or the ad is simply printed by the user). Finally, the ad server sends a purchase receipt display screen such as the display screen 152 shown in FIG. 22 to the user with a purchase reference number indicating that the ad purchase process is completed.

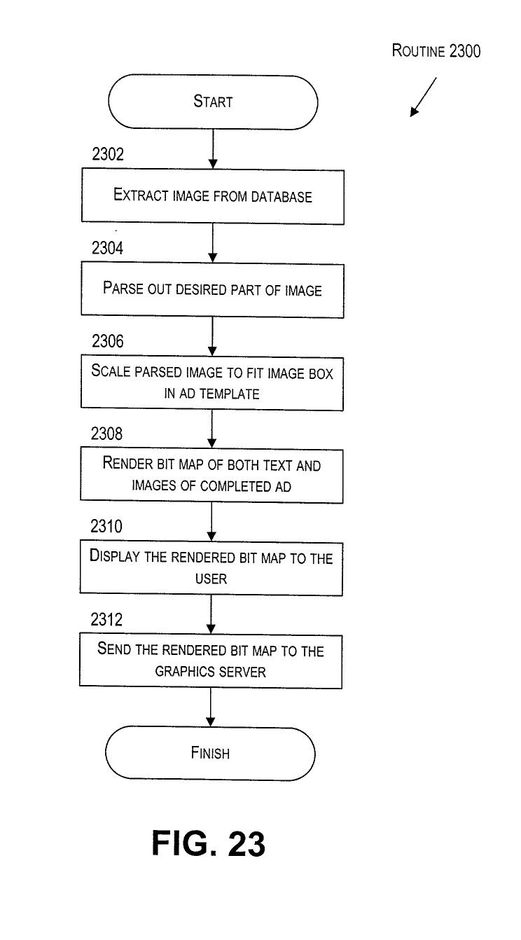

Referring now to FIG. 23, there is shown is a logic flow diagram illustrating an alternative routine 2300 for rendering the ad. As described above, at step 706 of routine 700 (FIG. 7), the selected controlled resources are associated with the selected ad template. And at step 810 of routine 800 (FIG. 8), the selected ad template and the selected controlled resources are sent to the graphics server for preparation into a print-ready ad. It will be understood that some of the controlled resources are images (e.g., photos and logos) stored electronically as bit maps, and some are text (e.g., headlines, ad body text, special offers) that are not stored as bit maps. Accordingly, when using conventional programming techniques, the ad send to the user for display will be a depiction of, but not necessarily the same physical thing as, the ad sent to the graphics server.

In order to convert the image and text controlled resources into a single bit map, the rendering logic routine 2300 can be utilized with the ad-making method 500. The routine 500 includes at 2302 extracting an image from a database storing the controlled resources, wherein the selected controlled resource comprises the image. The image can be a photograph, a user or co-branding logo, or another controlled resource or portion thereof. The database can be selected and configured for storing controlled resources including text and/or images. The ad server includes software for extracting the controlled resources from the database and also for updating them. Such software is commercially available under the trade name COLD FUSION™.

The routine continues at 2304 by parsing out a desired part of image for use in the ad. Thus, the entire image can be used or a portion of it can be cropped out of the image. At 2306 the parsed image is scaled to fit an image box in the selected ad template. The ad templates can have uniform image box sizes or different templates can have different sized image boxes. So the dimensions of the image box of the selected template may need to be determined first.

Then at 2308 a bit map is rendered of the ad template with the parsed image and any ad text or other controlled resources text and images. For example, the bit map can be rendered by a rendering module stored on the ad server and including software for converting all of the selected controlled resources, including text and images, into a single bit map of the ad. Such software is commercially available under the trade name SHOCKWAVE™.

Next, at 2310 the routine includes sending the rendered bit map to the user for display and at 2312 sending the rendered bit map to a graphics server for preparation into a print-ready ad. Of course, the same rendered bit map can be printed directly by the user, its client headquarters, or its local print shop, or first sent to a legal server for approval, or elsewhere, as may be desired. In any event, the user views the same rendered bit map version of the ad as is sent to the printer, so what the user sees is what it gets.

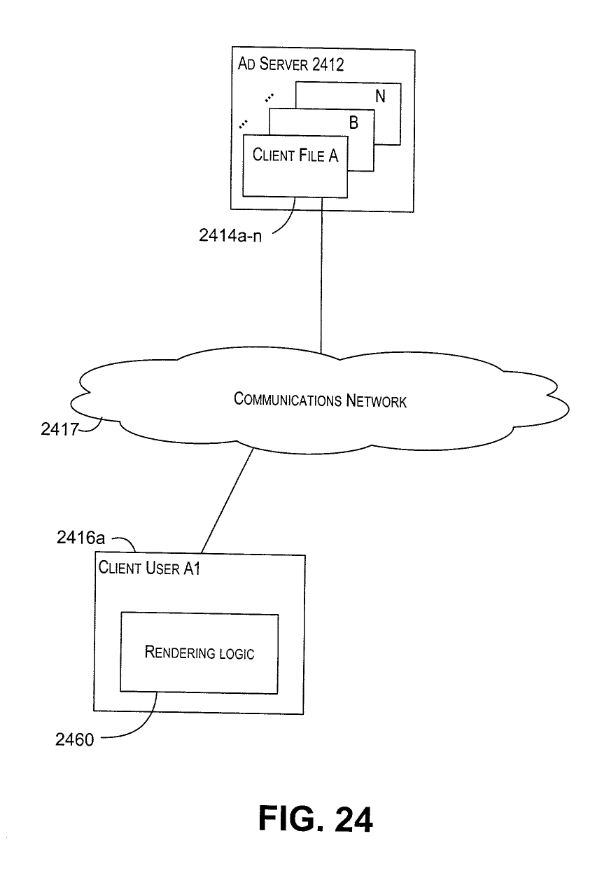

FIG. 24 is a functional block diagram illustrating the system architecture of an ad-making system 2400 according to an alternative embodiment of the present invention. Similar to the ad-making system 10 of the above-described embodiment, system 2400 includes an ad server 2412 having a processor, an on-line interface, and the computer readable medium storing the controlled resources. The on-line interface is connected to a communication network 2417 configured for communicating with the remote users, such as user 16a.

In this configuration of the system 2400, the rendering module 2460 is stored on the user device 16a. Thus, the ad server sends to the user the selected ad templates and other controlled resources, and the rendering module renders the bit map of the ad locally on the client's user device. It will be understood that the bit map file of the assembled ad can be significantly larger than the component controlled resources files. Accordingly, in this system configuration the downloaded files are smaller so the download time for the user is decreased. Also, this configuration results in a “thin” client with minimized computer resources on the client side, and the database stored remotely in the ad server. Of course, after the user renders the bit map file of the ad locally, then the user can send the rendered bit map directly to a printer or indirectly to a printer after sending it to a legal server for approval; a graphics server for print preparation, the database for storage, or elsewhere, ad desired.

In view of the foregoing, it will be appreciated that the present invention provides an ad machine that enables a user to select ad resources from a library of pre-approved controlled resources so that the user can quickly and easily make ads. Also, the ad resources are pre-approved for use by certain of the users, thereby streamlining the ad-making process and reducing any legal exposure for misusing ad resources. Additionally, the ad machine may be embodied in an application service provided on a global network for use by a large number of users at remote locations.

In the embodiments described above and the following claims, the use of a singular or plural form of a term is not intended to limit the term to that form. For example, the words “a,” “an,” and “one” are not intended to mean “only one” but can also mean “more than one.” Also, the method steps described herein are not intended to be limited to the specific sequences described but can be carried out in other sequences.

It should be understood that the foregoing relates only to embodiments of the invention, and that numerous changes may be made therein without departing from the spirit and scope of the invention as defined by the following claims.

The invention claimed is:

1. A computer-storage medium storing computer-readable instructions and data, comprising:
a database of controlled resources usable for the construction of ads by an authorized set of users;
control logic for providing the authorized users with access to the controlled resources in accordance with a predefined implementation methodology; and
rendering logic for rendering ads using the controlled resources in accordance with the control logic.

2. The computer-storage medium of claim 1, wherein the controlled resources are selected from the group consisting of ad templates, photos, headlines, ad body text, user logos, co-branding logos that are pre-approved for use with the user logos, and special offers.

3. The computer-storage medium of claim 1, wherein the control logic implementation methodology comprises:
receiving ad definitions including from the authorized users; and
finalizing the ad based on the ad definitions.

4. The computer-storage medium of claim 3, wherein the control logic implementation methodology further comprises:
submitting a request for an approval of the ad definitions; and
receiving the approval.

5. The computer-storage medium of claim 3, wherein the step of receiving ad definitions includes:
receiving an ad resource not stored in the database from one of the authorized users;
submitting a request for an approval of the ad resource;
receiving the approval; and
storing the resource in the database as one of the controlled resources.

6. The computer-storage medium of claim 3, wherein the controlled resources comprise ad templates, and the step of receiving ad definitions includes:
receiving a selection of one of the ad templates from one of the authorized users;
sending to the user only predetermined ones of the controlled resources that are correlated to the selected ad template, or a menu thereof; and
receiving a selection of one or more of the predetermined controlled resources from the user.

7. The computer-storage medium of claim 1, wherein the control logic implementation methodology comprises amending and appending the controlled resources.

8. The computer-storage medium of claim 1, wherein the control logic comprises password protection methodology.

9. The computer-storage medium of claim 1, wherein the control logic comprises a hierarchical user access methodology.

10. The computer-storage medium of claim 1, wherein the control logic comprises methodology for maintaining records relating to the use of the controlled resources and producing reports based on the records.

11. The computer-storage medium of claim 1, wherein the control logic comprises methodology for billing the users.

12. The computer-storage medium of claim 1, wherein the rendering logic comprises:
extracting an image from the database;
parsing out a desired part of the image;
scaling the parsed image to fit within an image window in a selected ad template;
rendering a bit map of the ad template and the parsed image;
displaying the rendered bit map to the user; and
sending the rendered bit map directly or indirectly to a graphics server, a legal server, or a printer.

13. The computer-storage medium of claim 1 implemented in multiple instances, wherein each instance is customized for an associated client and is accessible by an associated set of users.

14. A computer-controlled apparatus comprising the computer-storage medium of claim 1.

15. The apparatus of claim 13, wherein the apparatus is configured for communication with a plurality of remote user devices and the rendering logic is stored on the user devices.

16. A networked computer system comprising the apparatus of claim 13 and further comprising a graphics server.

17. A method of constructing an ad-making apparatus, comprising:
defining a set of controlled resources approved for use in an ad program of a client;
defining a control logic appropriate for an administrative structure of the client;
deploying the controlled resources on a computer system;
deploying the control logic on the computer system; and
providing access to users associated with the client in accordance with the control logic.

18. The method of claim 17, wherein the controlled resources are selected from the group consisting of ad templates, photos, headlines, ad body text, user logos, co-branding logos that are pre-approved for use with the user logos, and special offers.

19. The method of claim 17, wherein the step of defining controlled resources comprises:
obtaining or creating an ad resource;
submitting a request for an approval for the client to use the ad resource;
receiving the approval; and
storing the approved ad resource as a controlled resource accessible by the users.

20. The method of claim 19, wherein the controlled resources comprise ad templates, and the step of defining controlled resources further comprises associating pre-determined ones of the controlled resource with pre-determined ones of the ad templates.

21. The method of claim 17, wherein the step of providing user access comprises connecting the apparatus to a global communications network.

22. The method of claim 17, further comprising the step of repeating the method steps for additional clients.

23. A computer-controlled ad-making apparatus, comprising:
a database of ad templates and other controlled resources usable for the construction of ads by an authorized set of users, each controlled resource preapproved for use by the authorized users, each ad template having one or more of the other controlled resources associated therewith;
control logic for providing the authorized users with access to the controlled resources in accordance with a predefined implementation methodology that provides for receiving a selection of one of the ad templates from one of the authorized users, sending to the user the controlled resources that are associated with the selected ad template, or a menu thereof, and receiving a selection of one or more of the predetermined controlled resources from the user; and
rendering logic for rendering ads using the controlled resources in accordance with the control logic.

24. The apparatus of claim 23, wherein the controlled resources are selected from the group consisting of ad templates, photos, headlines, ad body text, user logos, co-branding logos, and special offers.

25. The apparatus of claim 23, wherein the control logic implementation methodology provides for:
receiving an ad resource not stored in the database from one of the authorized users;
submitting a request for an approval of the ad resource;
receiving the approval; and
storing the resource in the database as one of the controlled resources.

26. The apparatus of claim 23, further comprising a plurality of client files stored thereon, each client file associated with a client and with pre-determined ones of the users that are associated with the client, wherein the control logic implementation methodology comprises correlating pre-approved ones of the controlled resources with each of the client files and permitting access to each client file by the client and the associated users.
